(19) United States
(12) Patent Application Publication
(10) Pub. No.: US 2007/0273550 A1
(43) Pub. Date: Nov. 29, 2007

(54) Smart ceiling tiles and method of using

(76) Inventors: Marcus Stephen Price, Zephyrhills, FL (US); M. J. Vassar Price, Zephyrhills, FL (US); Robert John Stephens, Zephyrhills, FL (US)

Correspondence Address: FRANK B. ARENAS, Esq., P. O. BOX 600, 2327 TAYLOR AVENUE, COLEMAN, FL, 33521, US

(21) Appl. No.: 11/807,249

(22) Filed: May 25, 2007

Related U.S. Application Data
(60) Provisional application No. 60/808,751, filed on May 26, 2006.

(51) Int. Cl. G08C 19/00

(52) U.S. Cl. 340/870.3

(57) ABSTRACT

A Smart Ceiling Tile and Method of Using is disclosed in various versions of the invention. One version is a system for a ceiling sign, comprising a means for suspending from or connecting to a ceiling at least one horizontal or nearly horizontal frame of suitable width, length and height, and at least one ceiling tile of suitable width, length and height, disposed on or in the frame, and the ceiling tile having means for conveying information to one of the senses. Another version is a process of using a ceiling tile, said process comprising the steps of: (a) suspending at least one horizontal or nearly horizontal frame from a ceiling; (b) disposing on or in the frame at least one ceiling tile further comprising a pre-determined configuration of means for conveying information to one of the senses; (c) allowing the means for conveying information to one of the senses to communicate with one of the senses of a user.

This U.S. Non-Provisional Utility Application for Patent incorporates by reference (to the extent that does not conflict with the disclosure contained herein) and claims the benefit and priority of pending U.S. Provisional Application having Ser. No. 60/808,751 and filed May 26, 2006 for “Smart Ceiling Tiles and Method of Using” commonly owned with this application.

### BACKGROUND OF THE INVENTION

1. Field of the Invention

The present versions of invention relates generally to ceiling tiles and suspended ceiling systems. Some versions of the invention particularly relate to ceilings tiles and arrays of ceiling tiles used with visual indicia, signals, and/or markers for informative, educational, advertising and other communication uses. Other versions of the invention also more particularly relate (in alternative embodiments) to a “smart” ceiling using state-of-the-art technologies to advance the ceiling tile/suspended ceiling industries to new levels of usefulness such as incorporating lights, audio chips for verbal commands during incidents of low visibility, motion sensors to trigger advertising or safety commands when desired and RFID (radio frequency identification), GPS (Global Positioning Satellite), radio and other wired and/or wireless communication means and sensor-type chips to track and/or send/receive data defined by the user.

2. Description of the Prior Art

U.S. Pat. No. 5,282,331 discloses a display module.

U.S. Pat. No. 6,397,531 B1 discloses a ceiling display system.

U.S. Pat. No. 6,851,211 B2 discloses a ceiling mounted display sign.

U.S. Pat. No. 5,480,116 discloses a sign holder.

U.S. Pat. No. 4,528,746 discloses a suspended ceiling sign.

U.S. Pat. No. 6,610,160 discloses a method for resurfacing a ceiling tile.

U.S. Pat. No. 4,786,543 discloses a ceiling tile of expanded polystyrene laminated with embossed vinyl sheet.

None of the cited prior art discloses or teaches a ceiling sign using a ceiling tile direct-printed with a flatbed printer or (in alternative embodiments) a ceiling tile that uses pressure sensitive adhesive vinyl prints for indicia thereon. Further, none disclose the new and useful feature of one embodiment of the present invention to use a replacement membrane (with or without adhesive) to replace broken or discolored/stained ceiling tile with indicia thereon. None disclose the novel use of a suspended ceiling grid array structure for super-graphics, large murals and/or other communication purposes. None disclose (in alternative embodiments) ceiling tiles that use lights, audio chips for verbal commands during incidents of low visibility, motion sensors to trigger advertising or safety commands when desired and RFID (radio frequency identification), GPS (global positioning satellite), radio and other wired and/or wireless communication means and/or sensor-type chips to track and/or send/receive data defined by the user. This new, useful and unobvious smart ceiling tiles (device, system and methods) addresses the disadvantages and needs of the prior art.

Various embodiments of this invention take advantage of the typically unused surface of a building and/or room, the ceiling, and use it in an advantageous and profitable way for advertising, education, safety information, communication and/or input/output sensors for data transfer.

### SUMMARY OF THE INVENTION

It is an object of the invention to take advantage of typically unused surfaces (ceilings) and use them for with visual indicia, signals, and/or markers for advertising, education, safety information, informative and/or other types of communication. Another object of the invention is to use a suspended ceiling grid array structure for super-graphics, large murals and/or other communication purposes. It is another object of the invention (in one embodiment) to give the operator an easily tracked computer-based system utilizing input and/or output sensors for data transfer for billing and payment for signs used on ceiling tiles. It is another object of the invention (in alternative embodiments) to remotely track and communicate with handheld computers, computer systems, cell phones (smart cell phones), PDA (Personal Digital Assistants), MP3 and similar type electronic devices and BlackBerry-type electronic devices. Another object (in some embodiments) is to use motion sensors and/or smoke/heat sensors for safety uses for people in buildings during fires. Another object (in some embodiments) is for the smart ceiling tiles to provide information and data via visual, audio, digital, and/or analog communication means (wired or wireless, including VoIP—Voice over Internet Protocol) safety uses for people in buildings during fires. All communication means may be in real-time or delayed-time and encrypted or unencrypted.

Versions of the invention may be used for ceiling advertising in bowling alleys, offices, stores and all other type buildings/structures/rooms that people might inhabit temporarily or permanently. Other uses are for ceiling educational information in schools and other teaching environments. Other uses are for hospital ceilings for safety and location information for visitors and employees, while also utilized on ceilings over patient beds for entertainment and amusement to help prevent boredom.

For instance, in case of a fire and smoke resulting in low or decreased visibility inside of a building, a version of the invention could give verbal and/or visual warnings and/or give verbal directions to escape routes from the burning building, greatly enhancing safety.

Advantages over the prior art include: 1) Less expensive advertising space than conventionally-used surfaces; previously unused and wasted space/surfaces can now be utilized for profit; 2) Scalable to grand format image sizes using the already in place (and paid-for) ceiling grid system, easily changed; 3) Minimal maintenance versus wall or floor signs which need constant cleaning from foot traffic and/or graffiti, and; 4) Resistant to tampering and/or vandalism due to inaccessible location for most people.

This new and useful smart ceiling tile device, system and methods accomplishes at least one, some or all of these objectives; the objects of this invention are achieved and the present invention provides a new and useful article of manufacture, device, system and methods of use for conveying unique visual, marker, signal and other-types of communication.

The foregoing objects, benefits and advantages of versions of the invention are illustrative of those which can be addressed by versions of the invention and not intended to be limiting or exhaustive of the possible advantages that can be realized. These and other advantages will be apparent from the description herein or can be learned from practicing versions of the invention, both as embodied herein as examples or as modified in view of any variations which may be apparent to those of ordinary skill in the art. Therefore, the invention resides in the novel devices, methods, arrangements, combinations and improvements herein shown and described as examples and not limited therein.

### BRIEF DESCRIPTION OF THE DRAWINGS

In the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a plan view of the ceiling array with structural/reference grid (as viewed by an observer on the room/building floor) with visual indicia, markers and signals thereon comprising letters, for example (and advertising slogan and/or logo if desired).

FIG. 2 depicts a plan view of the ceiling array with structural/reference grid (as viewed by an observer on the room/building floor) with visual indicia, markers and signals thereon comprising super-graphics (and artwork and/or logo if desired).

FIG. 3 depicts a schematic of the components for an RFID-enabled smart ceiling tile for sign owner/lessor and interaction with smart ceiling tile signs at lessee's building location.

FIG. 4 depicts a schematic of the components for an Internet-enabled smart ceiling tile for sign owner/lessor, customer and interaction with smart ceiling tile signs at lessee's building location.

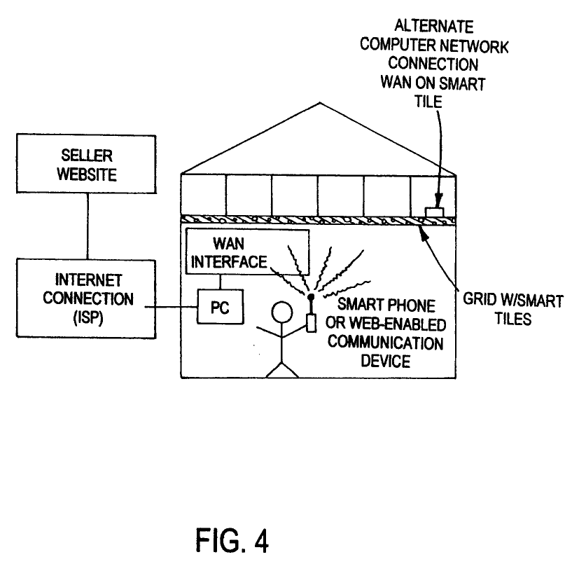

FIG. 5 depicts a schematic of the device, system and methods using optional components for various embodiments and interaction.

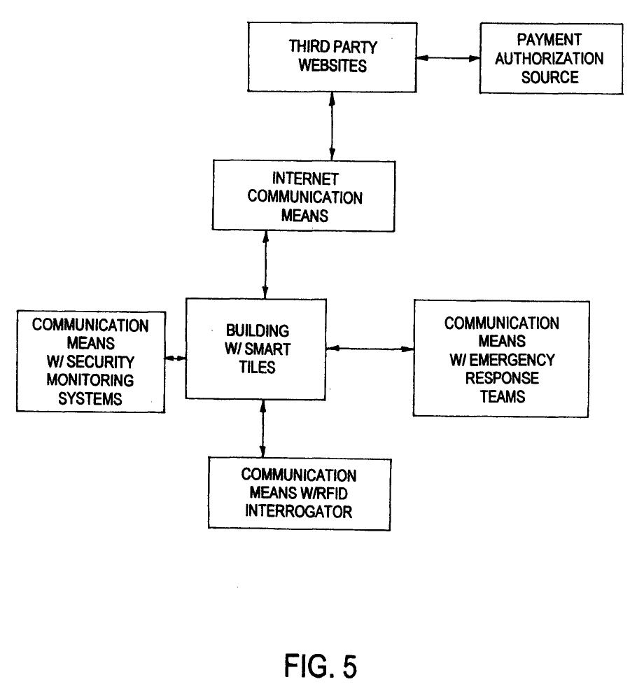

FIG. 6 depicts a typical smart ceiling tile and schematic with optional accessory package using one, a plurality, some or all of the components as desired by the user.

FIG. 7 depicts a typical speech synthesizer, audio and communication in schematic format.

It should be understood that in certain situations for reasons of manual or computational efficiency or ease of maintenance, the ordering of the blocks of the illustrated flow charts could be rearranged or moved inside or outside of the illustrated loops by one skilled in the art. While the present invention will be described with reference to the details of the embodiments of the invention shown in the drawings (and some embodiments not shown in the drawings), these details are not intended to limit the scope of the invention.

### DETAILED DESCRIPTION OF THE PREFERRED EMBODIMENT

The apparatus of the invention is conveniently fabricated by conventional and standard methods using conventional and standard materials common in the printing, sign-making, computer and electronic industries. The device is assembled and fabricated from standard materials and methods now used in the appropriate industries.

To make the invention in its various embodiments, one skilled in the art would assemble, install, configure and connect appropriately at least one, a plurality, some or all of the following components (which are used for illustration only and not intended to be limiting) in the ordinary and customary practice of the art (all owner's manuals, user's manuals, technical specifications and/or other printed documents available concerning the following products, hardware and/or software, components, peripheral devices and/or necessities are hereby incorporated by reference).

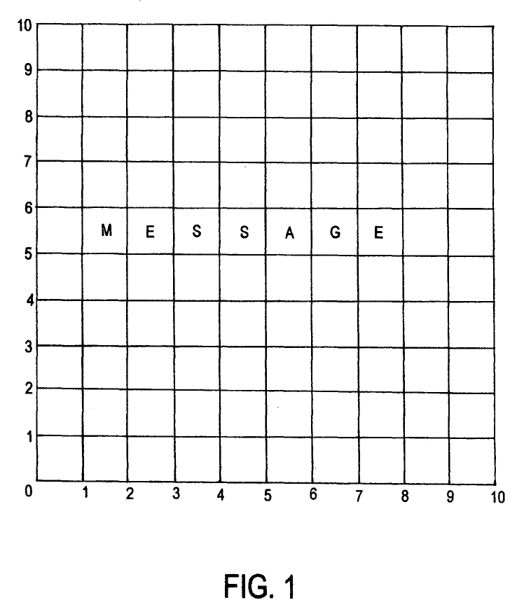

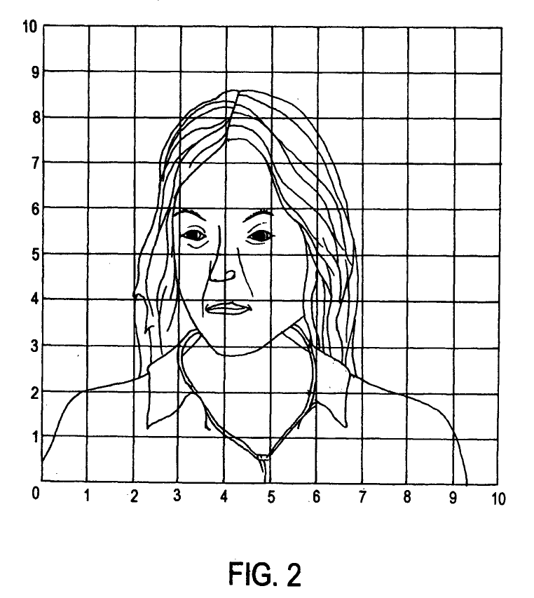

As shown in FIG. 1 and FIG. 2, the device is typically fabricated from a suspended ceiling grid array structure (well known in the industry, also called a T-bar ceiling track, which is suspended by wire from the building structure) and rigid or flexible membranes and/or replacement ceiling tiles, such as those manufactured by Armstrong Building Products, Armstrong World Industries, 2500 Columbia Avenue, Lancaster, Pa. 17603. These ceiling tiles are common in the industry and typically are 2 feet by 2 feet square (or 2 feet by 4 feet rectangular) and about one-half inch thick, such as model #420 Random Fissured contractor's ceiling tiles.

The rigid and/or flexible membranes may be comprised of and/or be fabricated from aluminum, stainless steel or like metals or any other suitable material. The replacement tiles may also be fabricated from non-metallic materials for lighter weight corrosion resistance. Theses non-metallic materials include, among others, conventional polymers such as, for example, polystyrene, polycarbonate, polyurethane, polyethylene, phenol formaldehyde resins, polybutylene, Teflon and the like. These above-mentioned materials are examples and do not limit the types of materials that can be used to make and use the ladder; any and all suitable materials may be used. The components of the device and/or system may be integrated together by standards means such as welding, bolting, gluing, riveting, fastening and/or any other suitable means.

Printing for some of the various embodiments in best mode uses a flatbed printer. Flatbed printing will often prove to be more cost-effective than many routine techniques. This is particularly shown true for shorter production runs. There will also be instances where flatbed printing (either ink jet or UV-cured) is economical for much longer production runs, on the bases of reduced inventory and storage costs, the need for just-in- time manufacturing or the viability of new business communication needs.

Typically, a flatbed printer such as the 720 UVZ model made by Raster Printers, Inc., 2192 Bering Drive, San Jose, Calif. 95131, is used to direct print on the ceiling tile or to membranes (flexible or rigid), such as vinyl (or other type plastic), that is adhered to the ceiling tile. Or, a rigid membrane (opaque, translucent and/or transparent) may be printed and substituted in place of the ceiling tile. Other types of media on which advertising, slogans, logos and all other types of indicia may be printed include, but not limited to, flexible uncoated roll media, including adhesive back and banner vinyl, canvas and banner paper. Rigid media include Fome-Cor board, polyvinyl (PVC) sheet styrene, aluminum-plastic, composite sheets, plexi-glass and common acoustic ceiling tiles.

The printer may also print bar codes on the tiles for use with bar code scanners and integrated scanning technologies for inventory, production and/or tracking uses and/or any other user-defined use.

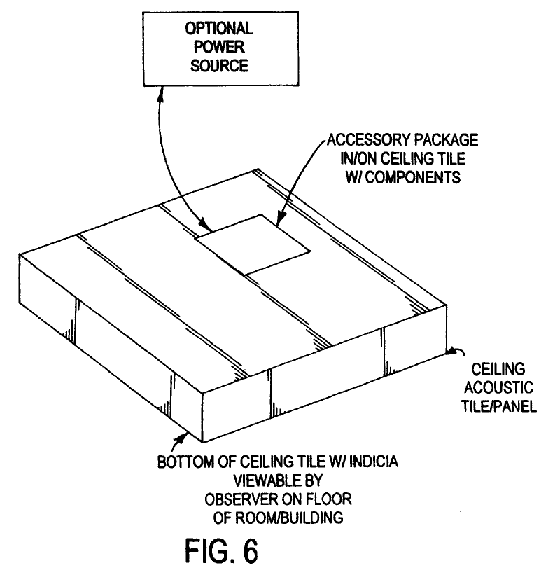

Typically, additional (optional) components are used in various embodiments and contained in the accessory package as shown in FIG. 6. Such components (which are used for illustration only and not intended to be limiting) may include a battery and/or solar photovoltaic (PV) power source and/or conventional DC or AC electric power sources, video camera, still camera (both digital and photosensitive film-based), audio microphone, audio speakers, GPS (Global Positioning Satellite) transmitter/receiver, RFID (radio frequency identification) chip and/or RFID interrogators, video and/or audio recorders (either self-contained or wireless to a remote receiver), cell phone, smart cell phone, laser beam emitters/detectors, motion sensors, smoke detectors, heat detectors, lights (either constantly on or blinking at predetermined intervals) and other type sensors (any combination of visual, audio, tactile, aromatic and/or taste sensors) and/or devices as desired and configured by the user.

Versions may include a means for conveying information to one of the senses (any combination of visual, audio, tactile, aromatic and/or taste senses, human and/or animal senses, mechanical and/or electronic sensors).

One embodiment may contain a GPS tracking or sensor chip, which may be contained in the accessory package as shown in FIG. 6, (such as those offered by KCS BV, Kuipershaven 22, 3311 AL Dordrecht, The Netherlands, Fax: +31 (0)78 6312659 or Fax2: +31 (0)20 5248130, www.gprs.tv) and other necessary components such as power source (battery) and peripherals well known to one skilled in the art, may be used to track data remotely.

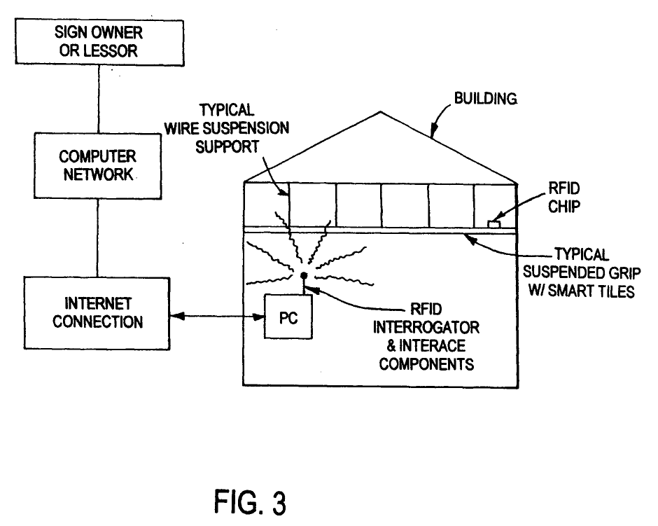

Another embodiment, as shown in FIG. 3, may contain a RFID (radio frequency identification) chip/system (such as those offered by Precision Dynamics Corporation, 13880 Del Sur Street, San Fernando, Calif. 91340-3490 USA, E-mail: info@pdc-rfid.com, Fax: 818.686.9315, www.pdcorp.com or IBM Corp., at www.ibm.com, IBM Corporation, 1133 Westchester Avenue, White Plains, N.Y. 10604, United States) and RFID interrogators and/or other necessary components such as power source (battery) and peripherals well known to one skilled in the art, may be used to track data remotely. An RFID embedded in the ceiling tile can allow third-party vendors that make and rent the ceiling signs to easily track data concerning the ceiling sign. Inventory control, billing for advertising, payment for advertising, tracking seasonal image change requirements (Christmas, Easter, etc.) and accounting uses may be accomplished via a communication means, including the World Wide Web (WWW) and Internet. Interrogators may be self-contained or coupled in communication with a computer or computer system with the required receiver, transmitter and antennae, well known in the industry.

Another embodiment may contain a remote wireless video camera, which may be contained in the accessory package as shown in FIG. 6, (such as those offered by www.x10.com, 1-800-675-3044, (253) 437-3800, 19823 58^{th} Place South, Kent, Wash., 98032 or www.seemorewildlife.com, SeeMore Wildlife Systems, 127 E Bunnell, Homer, AK 99603, (907) 235-1492, sales@seemorewildlife.com) and other necessary components such as power source (battery) and peripherals well known to one skilled in the art for reconnaissance in law enforcement, military, security and/or recreational uses. These intrusion detection devices and communication means are well known in the building security industry.

Another embodiment may contain a radio, which may be contained in the accessory package as shown in FIG. 6, (receive only, transmit only or both transmit/receive) or walkie-talkies (such as those offered by Cobra Electronics Corporation, 6500 West Cortland Street, Chicago, Ill. 60707, www.cobraelectronics.com, such as the “MicroTalk”) and other necessary components such as power source (battery) and peripherals well known to one skilled in the art, for audio communication with the building and/or room occupants via spoken words, sounds, music, warnings, sirens, and other audio-type communication, for example.

Another embodiment may contain a cell phone, which may be contained in the accessory package as shown in FIG. 6, (such as those offered by Nokia at www.nokia.com, Nokia Head Office, Keilalahdentie 2-4, P.O. Box 226, FIN-00045 Nokia Group, Finland, Tel. +358 (0) 7180 08000) and other necessary components such as power source (battery) and peripherals well known to one skilled in the art, to communicate with other cell phones, remote computers or other electronic communication devices.

Another embodiment may utilize a solar cell (or photovoltaic cell(s)), as shown schematically in FIG. 6, such as those offered by Real Goods, Inc., www.realgoods.com, 13771 S. Highway 101 Hopland, Calif. 95449, ph. 707/744-2100 fax 707/744-1342) and other necessary components such as power source (battery) and peripherals well known to one skilled in the art, for charging any power system (batteries) for electronics used with the device, enabling an sustainable power source for an indefinite time, if needed.

Another embodiment may utilize smoke, carbon monoxide and heat detectors, which may be contained in the accessory package as shown schematically in FIG. 6, such as those made by FireX Corp., available through Invensys, 1354 Clifford Ave., Loves Park, Ill., 61132. The FireX 501 Multi-Function Relay Module works with FireX Smoke, CO and combination Smoke/CO alarms, activating door closers, fans, strobe lights and other secondary devices that will alert hearing impaired individuals and other occupants that a smoke and/or CO alarm signal has sounded. The Multi-Function Relay Module can be interconnected with up to 18 compatible devices. In addition the Multi-Function Relay Module can be used in conjunction with fireplaces, furnaces, water heaters and other appliances, turning them off or opening fresh air dampers in the event of a potential hazard.

Additionally, The Firex 242 Hearing Impaired Kit features a 41216 120V AC Smoke Alarm, 499 FireX Relay Module, GXS-120-177 strobe light (177 candela), and a wiring instruction sheet (incorporated herein by reference). The 41216 Smoke Alarm has an 85 decibel horn, test switch and lighted power/alarm LED indicator; the LED flashes once per minute to confirm AC power. When in alarm, the LED (41216 Smoke Alarm) flashes rapidly once per second. The GXS strobe light utilizes a Xenon flash tube which generates a high-intensity light, visible from all sides of the lens. The GXS Remote Strobe is intended to provide a visible notification signal for the purpose of life safety and property protection. Transmitters can be utilized to send spoken directions to smoke hoods used by occupants in the burning building trying to escape, as well as messages to fire/emergency response teams.

Another embodiment may use wireless systems via hand-held computers and/or smart phones such as the Kyocera “Sidekick” multipurpose communication device and wireless systems, which may be contained in the accessory package as shown in FIG. 6, available from Kyocera International, Inc., Kyocera Wireless Corp., 10300 Campus Point Drive, San Diego, Calif., 92121 for communication with the system operator, customers and other third parties via email, voice mail, text messaging, instant messaging (IM), blogs, podcasts, RSS feed and/or via WWW websites with a unique URL (Universal Resource Locator) for specific operator desired and configured functions (well known in the art) and other communication means.

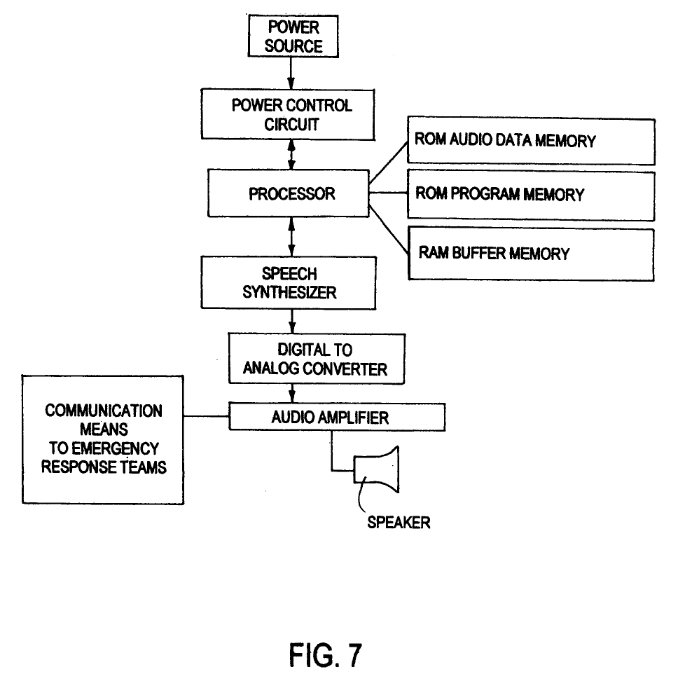

Another embodiment, schematically shown in FIG. 7, which may be contained in the accessory package as shown in FIG. 6, may use audio chips with a speech synthesizer and audio speaker to communicate via pre-programmed words and/or sentences with the building and/or room occupants for directions to emergency exits during fires, for example. It is understood that a person skilled in the art will know well that a synthesizer for speech and/or other type audio sounds, and memory for same, can utilize a processor. Audio data memory or an EEPROM may be incorporated, as well as digital-to-analog or analog-to-digital converters. The audio memory may be a removable cartridge (like those used in digital cameras or USB flash-drive storage media). Temporary storage to buffer memory (typically high-speed RAM) may be used.

Another embodiment may use laser beams (of any color and/or intensity), which may be contained in the accessory package as shown in FIG. 6, to detect motion of or send/receive data from building and/or room occupants. This type of motion sensing and data transmission device may be in communication with other type electronic devices if desired and configured by the operator, well known to the security industry. The laser beam(s) may also be utilized in fire/smoke emergency situations by implementation into the smart tiles and pointed downwardly to the floor and arranged such that the trail of laser beam may visually guide building occupants to emergency exits, or lead emergency response teams to occupants located in the building.

To make and use one version of the invention, a common acoustic ceiling tile is run through a flatbed printer to print a preconfigured image, advertising slogan, logo, letters, symbols, characters, artwork, or educational and/or entertaining visual indicia, signals and/or markers directly on the bottom surface of the ceiling tile. The printed ceiling tile is then placed in a suspended ceiling grid structure to support ceiling panels in the conventional manner and the ceiling tile is used as a ceiling sign. At least one, a plurality, some or all of the ceiling panels in a room and/or building may be printed and used in this manner, as shown in FIG. 1. Advertising indicia may comprise a single panel containing the complete image or an array of panels, each containing a part of the complete image. These large arrays of panels may be used to create full room-sized ceiling images, as shown in FIG. 2.

Or, to obtain the same result as referenced above, the advertising indicia could be printed onto pressure sensitive digital vinyl prints on flexible roll materials and then pressure mounted to the ceiling tile/panel (herein ceiling tile and ceiling panel are synonymous) or ceiling tile alternative.

Or, a replacement membrane with visual indicia (plastic, card stock or the like) with or without adhesive to the ceiling tile may be used with the weight of the ceiling tile in the suspended grid on top to secure it. This membrane may be used alone to replace the conventional ceiling tile.

Or, computer plotter-cut lettering and graphics made from pressure sensitive vinyl can be applied to existing or new ceiling tiles or ceiling tile substitutes.

Or, ceiling tiles may be screen printed for high volume/multiple location uses.

Other uses include puzzles and/or games printed on the ceiling tiles in waiting rooms to amuse and entertain those waiting. Uses in education/instruction may include school grade-specific educational examples such as the alphabet, periodic tables, multiplication tables, foreign language words, scientific images/diagrams, etc. may now be printed on the ceiling, utilizing otherwise “dead space” on ceilings. A version of the invention may use arrows and/or directional information (way finding systems) printed on the ceiling to lead people to multiple destinations in hospitals, schools and all other type buildings, including, but not limited to, emergency exits. A version of the invention may display artwork in small or large scale mural format. Another version of the invention may be used in retail stores for promotional advertising of products. Retail stores may create another income revenue stream by renting the ceiling tile signs to product line vendors.

A version of the invention may be used in doctors and/or dentists offices for advertising (or educating about) medical procedures and/or medicines/pharmaceuticals. Restaurants may use a version of the invention for theme-specific decorations for ambiance/atmosphere. Bowling alleys are noisy environments and usually require large areas of acoustic ceiling tiles (sometimes with a 45 degree slant towards the bowlers at the bowling line) and can sell advertising to local businesses for added income using a version of the invention. Malls and/or strip centers (as they are known in the industry) can make otherwise wasted surface space (the ceiling) for specific advertising and/or artistic decoration.

Another version may assist with building maintenance and/or repairs by using at least one tile positioned in alignment with a hidden piece of equipment above the suspended ceiling (like a wiring junction box, for example) to provide a signal or unique visual communication marker for the hidden junction box location.

With interactive communications technology via smart cell phones, BlackBerry-type devices, Palm TREO 700 and other web-enabled remote communication devices using the World Wide Web (WWW), Internet or other communications network, purchases may be accomplished through the ceiling sign. Features of this version of the invention can be implemented in several ways, including as an apparatus, device, PC (personal computer), form, system, a method and/or computer readable media having code devices for implementing the methods of the invention and producing sales of goods/products and/or services from third-party vendors. A commission from such sales may be paid to the site-owner of the interactive ceiling sign.

One version for interactive computer use may also include (and not limited to) a changeable message active matrix display. Or, video monitors, computer monitors and all other types of visual devices may be used such as LCD displays, High Definition Television (HDTV) displays, thin film displays and others may convey the unique visual indicia, signals and/or markers.

The invention preferably includes a computer infrastructure, wherein Internet-based sales/purchases can be achieved. Several embodiments of the invention are discussed below. The invention can be implemented in other ways, including as a system (including a computer processing and/or database system), a method (including a computerized method of constructing a tree data structure and a method for evaluating queries), an apparatus, a device, a computer readable medium, a computer program product, a web site on the Internet/World Wide Web (WWW) and/or a data structure tangibly fixed in a computer readable memory.

As a COMPUTER SYSTEM, an embodiment of the invention includes a database containing tables of data, a display device and a processor unit. The display device has a plurality of display areas (windows). The processor unit operates to access the database to retrieve the data from the corresponding associated tables and then display the retrieved data in the display areas.

As a GRAPHICAL USER INTERFACE (GUI) for a display screen of a computer, an embodiment of the invention includes a number of display areas (“windows”) for searching and displaying data. A variety of formats for searching and displaying data is provided. Searches can be performed by many parameters that are more fully disclosed below. Search results are graphically, textually and/or numerically displayed showing needed information pertinent to the Internet-based business and industry.

As a METHOD of displaying data on a display device of a computer system, the data being obtained from a relational database associated with the computer system, the display having “windowing” capability to provide a plurality of display areas, an embodiment of the invention includes the operations of sales in foreign countries. The method further includes Internet, (World Wide Web, WWW), wireless or wired communication systems for sales and payments to/from a remote seller by a customer in the building where the system and method is utilized.

As a COMPUTER READIBLE MEDIA containing program instructions for displaying data on a display device of a computer system, the data being obtained from a relational database associated with the computer system, the display having “windowing” capability to provide a plurality of display areas, an embodiment of the invention includes computer readable code devices for operator input, manipulation and output. This version of the invention's database and transmission of data may also include an encryption means and password access to prevent access or interception from unauthorized users. At least one, any, all and/or some software programming tools may be used by one skilled in the art such as Microsoft Visual Basic, VB.Net, Delphi, Embedded Visual Basic, Embedded Visual C++, Turbo Pascal, C#, CE.NET or any other programming tool.

The methods of this version of the present invention may be implemented as a computer program product with a computer-readable medium having code thereon. The program product includes a program and a signal bearing media bearing the program.

As an APPARATUS or DEVICE, a version of the present invention may include at least one processor, a memory coupled to the processor, and a program residing in the memory which implements the methods of the present invention via a communication means. For example, the apparatus may include a remote input device and/or smart portable device (such as PC, cell phone, smart phones, RFID, 3G third generation mobile network technology device, Palm Inc.'s TREO 700W, PDA, EDGD enhanced data for global evolution and 1xRTT devices, for example) with a sufficient amount of computer hardware, software, peripherals and necessities inside the office or other-type building where the device is located capable of communicating with optionally the smart tile components in the accessory package (as shown schematically in FIG. 6) at least one host computer with a sufficient amount of computer hardware, software, peripherals and necessities outside the office or building where the device is located and at least one database accessible to the host computer and the remote input device and a means for communicating in delayed-time or real-time between the remote input device and the host computer, and

a means for communicating in between the host computer and a credit card, payment authorization and/or approval source, bank and/or other medium of commerce for any payment type from purchaser acceptable to seller for payment of the products, goods and/or services.

The computer may also include a computer network accessible to and in communication with a plurality of computers, either wired or wireless. The computer may be a laptop. The data and means for communication may be encrypted or un-encrypted (plaintext or ciphertext).

The above-described device, system and method may also be used by a smart ceiling tile sign vendor to track, bill and receive payment from sign lessees.

For example, Figure X shows schematically a WWW system components; all services/products/goods are based per unit sold (per downloaded cell phone ring-tone, for example). The customer type, service/product/good type and payment type of versions of the invention may be defined by the system operator. Definitions may be modified or unmodified by other attributes. All communications and means of communicating concerning versions of the invention are either one-way (i.e. able to transmit or receive only) or two-way communications (i.e. able to transmit and receive data), or both, as needed alone or in combination.

Versions of the invention may input/output data manually or via email, text messaging, voice recognition, facsimile, scanner, printer and/or interact with independent outside vendor word processing software (such as Word or WordPerfect) and/or spreadsheet/database software (VisiCaic, Lotus, Microsoft Office, etc., QuickBooks, for example) for output-accounting and/or via a printer. Sensors in some versions detect and convey visual, audio, aromatic, taste and tactile to the senses of humans, animals, and/or mechanical sensors in communication with a computer. Such sensors are off-the-shelf devices that may be integrated into versions of the invention.

In one version, lease payments by the smart ceiling tile sign lessee to the sign owner per the monthly invoices for lease fees, as well as payments between customer and seller via the smart ceiling tile sign in another version, may be made via payment authorization and approval sources or via credit cards (or other medium of commerce, i.e. “pay orders” and “funds transfer” per U.C.C. Article 4A, for example) and customer/lessee payment(s) may be via modem/phone line, Internet/WWW (World Wide Web), corporate intranets, commercial networks, electronic funds transfer networks, telecommunications networks, satellite means, radio means, fiber optic cable, cablegrams, cell phone, smart phone or any other suitable medium of commerce, wired or wireless, alone or in combination. All data transmitted and received between the remote input device and host computer and/or between the host computer and/or credit card payment authorization and approval source (or other medium of commerce) may be encrypted or un-encrypted as the user desires. Payment may be made by customer/lessee by cash, ATM, credit card, debit card, smart card, check, electronic funds transfer (EFT), bank wire transfer, commercial account or any other type value acceptable for payment to the seller and/or lessor.

A customer may request any or all of the type services, products and/or goods (including options if desired). Thus, it is understood herein, “services, products and/or goods” is hereby defined as any or all of at least one unit or partial unit of the type services(s), product(s) or good(s) offered by the seller. It is also understood that whenever and/or is used in this patent application it means any combination or permutation of all, one, some, a plurality or none of each of the item or list mentioned, which is not intended to be limiting but merely for example and illustration. It is also understood that (s) designates either singular or plural. It is also understood that that “or” is an inclusive “or” to include all items in a list and not intended to be limiting and means any combination or permutation of all, one, some, a plurality or none of each of the item or list mentioned. It is also understood that “including” means “including but not limited to” any combination or permutation of all, one, some, a plurality or none of each of the item or list mentioned.

The bank payment authorization and approval source(s) may automatically access a card merchant authority and approval verification (via phone land line, Internet, radio, cell phone, satellite or any other transmissions means) and obtains authorization for payment. Another embodiment uses digital signatures to obtain customer's signature. Other optional hardware/software may be used with the invention such as digital camera, video camera, bar code scanner, microphone, speakers, digital scanner and other computer accessories and/or input/output devices, all well known in the industry.

To make the invention in its preferred embodiments, one skilled in the art would assemble, install and connect appropriately at least one, some or all the following components in the ordinary and customary practice of the art (all owner's manuals, user's manuals, technical specifications and/or other printed documents available concerning the following hardware and/or software, components, peripheral devices, accessories and/or necessities are hereby incorporated by reference): The computer, if used, may be any suitable-type platform such as PC, MAC, laptop, but the preferred hardware includes a personal computer (PC) or laptop computer which is a 100% IBM-compatible machine (with typical monitor, keyboard, etc.) with a Pentium processor or higher; a hard disk with at least 20 MB free space; a CD Rom Drive; a Mouse; 256 megabyte of memory (RAM); an EGA, VGA, 8514, Hercules, or compatible display; and a multitasking operating system (OS) such as Microsoft Windows or DOS, VMS, OS/2, UNIX, LINUX or any other suitable OS.

Alternately, the computer could be a computer server with the above-referenced hardware and appropriate server-software (SQL, APACHE, etc.) and/or HTML (Hypertext Mark-up Language) and/or XML (Extensible Markup Language) for an interactive World Wide Web (WWW) site URL (Universal Resource Locator) located at an Internet Service Provider (ISP) third-party location via TCP/IP or even a private TCP/IP network. Access to the web site may be made via web browsers such as Firefox, Mozilla, Netscape, Internet Explorer, etc. or any other suitable communication means. These browsers may be used alone or with integrated or stand-alone email programs such as Outlook Express, etc. or any other communication means, such as smart phones. All software is coded and installed according to the developer's or manufacturer's instructions, procedures and specifications. The above-referenced illustrative computer hardware/software is hereinafter referred to as a “computer system” and is for illustration only and not intended to be limiting as to what hardware/software (or virtual hardware) that may be used to practice the versions of the invention.

In one embodiment, the device, process, method and/or system performs all steps or functions and are accomplished automatically without human intervention. In another embodiment, the device, process, method and/or system performs all steps or functions and are accomplished automatically with some human intervention. In another embodiment, the device, process, method and/or system performs all steps or functions and are accomplished automatically with minimal human intervention.

The development and proliferation of GUIs has greatly enhanced the ease with which users interact with databases both in the searching stage and in the display of information. A conventional GUI display includes a desktop metaphor upon which one or more icons, application windows, or other graphical objects are displayed. Typically, a data processing system user interacts with a GUI display utilizing a graphical pointer, which the user controls with a graphical pointing device, such as a mouse, trackball, or joystick. For example, depending upon the actions allowed by the active application or operating system software, the user can select icons or other graphical objects within the GUI display by positioning the graphical pointer over the graphical object and depressing a button associated with the graphical pointing device. In addition, the user can typically relocate icons, application windows, and other graphical objects on the desktop utilizing the well known drag-and-drop techniques. By manipulating the graphical objects within the GUI display, the user can control the underlying hardware devices and software objects represented by the graphical objects in a graphical and intuitive manner.

User interfaces used with multi-tasking processors also allow the user to simultaneously work on many tasks at once, each task being confined to its own display window. The interface allows the presentation of multiple windows in potentially overlapping relationships on a display screen. The user can thus retain a window on the screen while temporarily superimposing a further window entirely or partially overlapping the retained window. This enables the user to divert the attention from a first window to one or more secondary windows for assistance and/or references, so that overall user interaction may be improved. There may be many windows with active applications running at once. Oftentimes, the windows may be (dynamically or statically) related such that modifying a query in one window results in changes to the displayed data in the other related windows, thereby “propagating” the changes throughout.

With one, some or all of the above components, one skilled in the art would proceed as follows for one version of the preferred embodiment, which is shown for illustrative purposes only and not intended to be limiting (as shown in Figure X):

A Web site is established on the WWW by a seller via an ISP (Internet Service Provider) using HTML, XML or any other suitable programming language. “Website Tonight”, available from www.godaddy.com, is an example. The web site pages typically are “virtual stores” such as Amazon.com, well known in the industry. The procedures for the use, navigation, input of data and interaction with the web site by customers are well known in the industry such as point-and-click on hyperlinks with a computer mouse computer input device, filling in electronic forms, sending/receiving email, speaking to the web site and listening to the web site via Voice over Internet Protocol (VoIP) The customer may communicate in question and answer format via a voice synthesizer connected to a processor. The web page input data is evaluated by the seller. The input data may be stored in computer memory. The seller communicates (via web page browser or email, preferably, but by any communication means) to the customer the price of the desired products, goods and/or services. If the customer elects to proceed with the purchase, the transaction is consummated in the customary manner and the services, goods and/or products are delivered via Internet download, postal delivery, common carrier and/or any delivery method desired by the parties to the transaction. Smart portable devices for Internet interaction (well known in the industry) by customers that may be used for this version of the invention are the T-Mobile Dash using Windows Mobile software, the iPhone by Apple computer, the Neo 1973 available at www.openmoko.org and the Nokia N800 Internet Tablet are typical of the types that may be used for versions of the invention, which are listed for illustration and/or example only and not intended to be limiting in this disclosure.

Smart portable device is herein defined as a cell phone combined with a computer with Internet access or a computer with built-in cell phone and/or other devices that access the World Wide Web (WWW) wirelessly. Smart portable devices typically include at least one of the following devices and/or function(s) and/or service(s) with transmit only and/or receive only and/or transmit and receive data, alone or in combination, for interaction with one of the senses and/or sensor (mechanical and/or electronic): cell phone, radio, hand-held computer, laptop computer, wireless computer, Adobe Acrobat, HTML, XML, text message, instant message, email, RSS feeds, blogs, web page, web site, Internet, World Wide Web (WWW), computer network, battery, power source, camera, audio microphone, audio speaker, Global Positioning Satellite transmitter, Global Positioning Satellite receiver, radio frequency identification chip, radio frequency identification interrogator, warning device, audio recorder, video recorder, laser beam emitter, laser beam detector, motion sensor, smoke detector, heat detector, heat emitter, light emitter, light detector, radio receiver, radio transmitter, electromagnetic receiver and electromagnetic transmitter.

Alternately, data may be transferred between the parties on the Internet and/or World Wide Web (WWW) via HTTP by a “cookie.” Passed to a web browser from a web server, a cookie is a data structure provided as part of the HTTP and TCP/IP protocol. Other protocols such as ATM, SNA, DECNET or any other suitable protocols may be used.

All versions of the invention have means for conveying information to one of the senses. These senses include those of humans and animals (seeing, hearing, smelling, feeling and tasting) and those of electronic and/or mechanical sensors (heat, smoke, pressure, temperature and any and all other types of sensors, which are listed for illustration and example only and not intended to be limiting.

The above-referenced menus, lists, options, functions, instructions, commands, sub-commands, applications, interactions, items, products, goods, groups and sub-groups are merely intended as illustration and examples, and are not intended by the inventor to in any way limit the addition, deletion or modification of any said menus, lists, options, functions, instructions, commands, sub-commands, applications, interactions, items, products, goods, groups and sub-groups as might be desirable or useful to someone skilled in the art.

As will be apparent to persons skilled in the art, such as a ceiling installer, website designer, computer programmer, electrical engineer or other similar-type individuals, various modifications and adaptations of the structure and method of use above-described will become readily apparent without departure from the spirit and scope of the invention, the scope of which is defined in the appended claims. Although the foregoing invention has been described in detail by way of illustration and example, it will be understood that the present invention is not limited to the particular description and specific embodiments described but may comprise any combination of the above elements and variations thereof, many of which will be obvious to those skilled in the art. Additionally, the acts and actions of fabricating, assembling, using, and maintaining the preferred embodiment of this invention is well known by those skilled in the art. The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1) A system for a ceiling sign, comprising;
a means for suspending from or connecting to a ceiling at least one horizontal or nearly horizontal frame of suitable width, length and height, and;
at least one ceiling tile of suitable width, length and height, disposed on or in the frame, and;
the ceiling tile having means for conveying information to one of the senses.

2) The system of claim 1 further comprising wherein one of the senses is a human sense.

3) The system of claim 1 further comprising wherein one of the senses is an animal sense.

4) The system of claim 1 further comprising wherein one of the senses is a mechanical or electronic sensor.

5) The system of claim 4 further comprising the mechanical or electronic sensor in communication with a computer or smart portable device.

6) The system of claim 1 further comprising wherein said means for conveying information to one of the senses further comprises indicia disposed on said ceiling tile.

7) The system of claim 1 further comprising wherein said means to convey information to one of the senses further comprises data disposed on said ceiling tile.

8) The system of claim 1 further comprising wherein said means to convey information to one of the senses further comprises visual means.

9) The system of claim 1 further comprising wherein said means to convey information to one of the senses further comprises audio means.

10) The system of claim 1 further comprising wherein said means to convey information to one of the senses further comprises tactile means.

11) The system of claim 1 further comprising wherein said means to convey information to one of the senses further comprises aromatic means.

12) The system of claim 1 further comprising wherein said means to convey information to one of the senses further comprises taste means.

13) The system of claim 1 further comprising an accessory package integrated into or onto the ceiling tile.

14) The system of claim 13 further comprising wherein the accessory package contains at least one component selected from the group consisting of battery, power source, camera, audio microphone, audio speaker, Global Positioning Satellite transmitter, Global Positioning Satellite receiver, radio frequency identification chip, radio frequency identification interrogator, audio recorder, video recorder, cell phone, laser beam emitter, laser beam detector, motion sensor, smoke detector, heat detector, heat emitter, light detector, light emitter, radio receiver, radio transmitter, electromagnetic receiver and electromagnetic transmitter.

15) The system of claim 13 further comprising wherein the accessory package contains at least one smart portable device.

16) The system of claim 15 further comprising the accessory package containing at least one smart portable device in communication with another smart portable device.

17) The system of claim 16 further comprising at least one smart portable device in communication with customer or emergency response team.

18) The system of claim 1 further comprising a plurality of ceiling tiles further compromising an array of ceiling tiles.

19) The system of claim 18 further comprising wherein each ceiling tile of the array of ceiling tiles further comprises a portion of the means for conveying information to one of the senses whereby the entire array further comprises the whole means for conveying information to one of the senses.

20) A process of using a ceiling tile, said process comprising the steps of:
(a) suspending at least one horizontal or nearly horizontal frame from a ceiling;
(b) disposing on or in the frame at least one ceiling tile further comprising a pre-determined configuration of means for conveying information to one of the senses;
(c) allowing the means for conveying information to one of the senses to communicate with one of the senses of a user.

21) The process of claim 20 further comprising:
(d) allowing a smart portable device in communication with the ceiling tile means for conveying information to one of the senses in the possession of the user;
(e) allowing the user to communicate with the smart portable device.

22) The process of claim 20 wherein the user is a customer or emergency response team.

23) The process of claim 21 wherein the user is a customer or emergency response team.

24) A system for a ceiling sign, comprising;
a means for suspending from or connecting to a ceiling at least one horizontal or nearly horizontal frame of suitable width, length and height, and;
a plurality of ceiling tiles of suitable width, length and height, disposed on or in the frame, and;
the plurality of ceiling tiles having means for conveying information to one of the senses, and;
and a smoke detector/warning device and laser beam light emitter integrated into some of the plurality of ceiling tiles in a predetermined configuration further comprising a trail that directs a building occupant to a building exit, such that when the smoke detector detects smoke and triggers the warning device, the laser beams allow the building occupant to find the building exit via the laser beam lights trail.

25) The system of claim 24 further comprising a speech synthesizer and speaker to provide spoken directions to allow the building occupant to find the building exit via the spoken commands.

26) A system for a ceiling sign, comprising;
a means for suspending from or connecting to a ceiling at least one horizontal or nearly horizontal frame of suitable width, length and height, and;
a plurality of ceiling tiles of suitable width, length and height, disposed on or in the frame, and;
the plurality of ceiling tiles having means for conveying information to one of the senses, and;
and a radio frequency identification chip emitter integrated into the plurality of ceiling tiles, the radio frequency identification chip containing data in a predetermined configuration.

27) The system of claim 25 further comprising a radio frequency identification chip interrogator.
